(19) United States
(12) Patent Application Publication
(10) Pub. No.: US 2018/0161961 A1
(43) Pub. Date: Jun. 14, 2018

(54) Slip Track K-Clamp

(71) Applicant: Robert E. Kopacz, JR., Rosamond, CA (US)

(72) Inventor: Robert E. Kopacz, JR., Rosamond, CA (US)

(21) Appl. No.: 15/840,959

(22) Filed: Dec. 13, 2017

Related U.S. Application Data
(60) Provisional application No. 62/433,430, filed on Dec. 13, 2016.

(51) Int. Cl. B25B 5/06

(52) U.S. Cl. CPC B25B 5/067; B25B 5/068

(57) ABSTRACT

A vice grip type enhanced C-clamp modified to more easily grip the slip tracks on I-beams, comprising narrowed or tapered jaws to fit through the slots of a slip track.

### CLAIM OF PRIORITY

This patent application claims priority under 35 USC 119 (e) (1) from U.S. Provisional Patent Application Ser. No. 62/433,430 filed Dec. 13, 2016, of common inventorship herewith entitled, “Slip Track Clamp,” which is incorporated herein by reference as though the same were set forth in its entirety.

### FIELD OF THE INVENTION

The present invention pertains to the field of clamps, and more specifically to the field of slip track clamps for gripping the slip tracks on I-beams, thereby rendering installation faster and more efficient.

### BACKGROUND OF THE INVENTION

Some inventions, i.e., cars, lightbulbs, television, personal computers, cellphones, indoor plumbing, change the way we live, and alter the habits of our entire society. These are what one might call groundbreakers: entirely new technologies, or adaptations of existing technology to accomplish things not previously thought possible. Such inventions mark the great milestones in humanity's technological history, and bring on huge changes in the life of a society. But groundbreaking inventions are understandably rare, and the great majority of inventions and innovations do not fall into this category. Instead, most successful inventions are small improvements that come into play gradually, so subtly that we hardly notice them, and bring not sweeping societal change but heightened individual convenience that then spreads to all people.

The prior art has put forth several designs for a clamp. Among these are:

U.S. Pat. No. 6,155,547 to Louie Gatanas provides a stud clamp that attaches across a first stud providing a stationary brace for a second perpendicular stud to be connected to the first, thereby facilitating the toe-nailing process. The stud clamp is adjustable to fit variety of stud widths and has a clamping mechanism for securely clamping the device to the first stud.

U.S. Pat. No. 6,578,452 to Thomas F. Duffy provides a vise grip locking tool which contains jaws that are capable of opening with a flick of the user's wrist. The tool comprises a first handle member, a second handle member, a lower jaw, and an upper jaw. The first handle member is pivotally attached to the lower jaw. The first end of the lower jaw is made up of four mutually interconnected sides having a guided slot extending through it. The upper jaw has an elongated shank that may slide along the guided slot of the lower jaw. A stop is present on the bottom of the shank preventing the upper jaw from escaping the guided slot. The second handle member is pivotally mounted to the lower jaw and includes a releasable lock which is made up of a spring-operated detent which engages teeth on the elongated shank.

U.S. Pat. No. 4,563,921 to John Wallace provides pliers including a frame having a hand grip portion and two, spaced, laterally projecting leg sections. At least one of the leg sections is fixed to the hand grip portion of the frame and has formed thereon a stationary jaw, which confronts a movable jaw that is carried by a support member that is mounted on the frame to extend transversely between its leg sections, and for reciprocation generally parallel to its hand grip portion. The support member is connected to a handle, which is pivotally mounted on the frame to reciprocate the movable member and its jaw in opposite directions, thereby to shift the movable jaw toward and away from the stationary jaw. The movable jaw is mounted on its support member for adjustment thereon into any one of a number of different positions, thereby to adjust the span between the jaws.

None of these prior art references describe the present invention.

### SUMMARY OF THE INVENTION

It is an object of the present invention to provide a slip track damp for gripping the slip tracks on I-beams, thereby rendering installation faster and more efficient.

### BRIEF DESCRIPTION OF THE DRAWINGS

FIG. 1 is a perspective view illustrating a slip track clamp, constructed in accordance with the present invention.

FIG. 2 is a perspective view illustrating the slip track clamp, constructed in accordance with the present invention, mounted on a slip track, being used in conjunction with a C-clamp.

### DETAILED DESCRIPTION OF THE INVENTION

The present invention, hereinafter referred to as a Slip Track Clamp is a line of enhanced C-clamps that are modified to more easily grip the slip tracks on I-beams, thereby rendering installation faster and more efficient. The Slip Track Clamp resembles a common C-clamp, or a C-shaped tool made of durable steel that is used as a security device in many carpentry, welding, and woodworking jobs. Yet, the Slip Track Clamp possesses several notable differences. While the Slip Track Clamp can be provided in various sizes to accommodate different needs, each Slip Track Clamp is smaller, and more lightweight, than standard C-clamps.

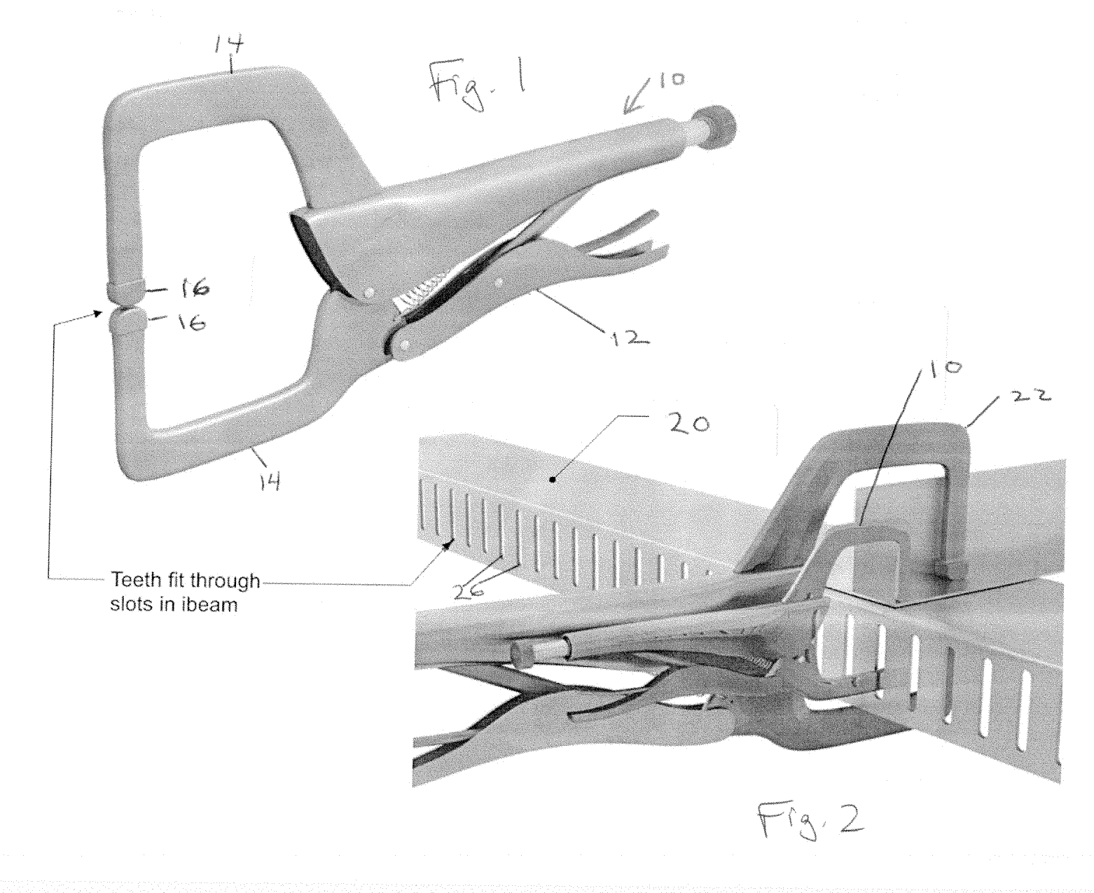

Please refer to the drawings. FIG. 1 shows the slip track clamp 10, comprising a vice grip clamp 12, having upper and lower jaws 14, wherein the jaws are tapered or narrowed at the ends of their teeth 16 in order to permit them to fit through the slots of a slip track 20. FIG. 2 shows use of the slip track clamp 10 being used in conjunction with C-clamp 22 on slip tack 20, and the jaws 16 of slip track clamp 10 fitting through the slots 26 of slip track 20.

Most notably, the jaws of the Slip Track Clamp' have been narrowed to permit passage through the slots of a slip track. In this manner, when the Slip Track Clamp is engaged, it is able to slide through the open slots of the slip track as well as under an I-beam, or K-scaffolding ensuring a secure grip during the installation process.

As designed, the Slip Track Clamp provides a simpler and more efficient means of achieving proper slip track installation whenever it is used. A more compact, easily handled version of the C-clamp, the Slip Track Clamp is able to access and swiftly secure hardware that laborious conventional methods with existing tools simply cannot achieve. The lightweight quality of this product, in addition to the creative modification of the clamp tips, proves safer to use for the professional, eliminating the struggles with common clamps that can sometimes result in injury. By attaching a Slip Track Clamp with just the squeeze of the hand, a user is able to achieve precision in just a matter of seconds. The advantages offered by the Slip Track Clamp facilitates cost savings as well as time savings, since the unit prevents mistakes and eliminates the need to employ additional, expensive tools. As clients depend upon professionals to attend to carpentry and construction jobs both quickly and correctly, the Slip Track Clamp ensures both, leading to satisfied customers who will return to users time and again for their needs.

With its universal design and ease of use, the Slip Track Clamp proves invaluable for both novice and seasoned professionals. Framing carpenters and other construction personnel will certainly appreciate the time-saving aspects of the Slip Track Clamp, as the product facilitates quick completion of common installation jobs.

Although this invention has been described with respect to specific embodiments, it is not intended to be limited thereto and various modifications which will become apparent to the person of ordinary skill in the art are intended to fall within the spirit and scope of the invention as described herein taken in conjunction with the accompanying drawings and the appended claims.

1. A slip track clamp for gripping the slip tracks on I-beams, comprising:
a C-clamp further comprising a vice grip handle and a pair of jaws having teeth, wherein the teeth come together, and further wherein the teeth are tapered, or narrowed or made small in order to allow the teeth to fit through a slot in a slip track.

2. The slip track clamp of claim 1, wherein the teeth are approximately ⅛ to ½ inch in thickness.

3. The slip track of claim 1, wherein the teeth are tapered in order to allow the teeth to fit through a slot in a slip track.

4. The slip track of claim 1, wherein the teeth are narrowed in order to allow the teeth to fit through a slot in a slip track.
